(19) United States
(12) Patent Application Publication
(10) Pub. No.: US 2005/0147945 A1
(43) Pub. Date: Jul. 7, 2005

(54) Focusing method and apparatus for light emitting device

(75) Inventor: John Lampl, Kowloon (HK)

Correspondence Address: MCDERMOTT WILL & EMERY LLP, 600 13TH STREET, N.W., WASHINGTON, DC, 20005-3096, US

(73) Assignee: Jasman Asia Ltd., Kowloon (HK)

(21) Appl. No.: 11/028,525

(22) Filed: Jan. 5, 2005

Related U.S. Application Data
(63) Continuation of application No. 10/396,703, filed on Mar. 26, 2003.
(60) Provisional application No. 60/367,204, filed on Mar. 26, 2002.

(51) Int. Cl. F41A 33/00; G01B 9/00

(52) U.S. Cl. 434/11

(57) ABSTRACT

A light emitting apparatus including an emitter configured to emit electromagnetic radiation of a predetermined spectrum including visible light and infrared light, and a plurality of focusing chambers, each focusing chamber including an aperture, wherein light from the emitter passes successively through at least a first of the chambers and an aperture of the first chamber, and through a second of the chambers and an aperture of the second chamber before exiting the apparatus.

### CROSS-REFERENCE TO RELATED APPLICATION

The present application claims priority to provisional U.S. patent application Ser. No. 60/367,204, filed on Mar. 26, 2002, which is incorporated herein by reference.

### TECHNICAL FIELD

The present disclosure relates to a new and improved focusing method and apparatus for a light emitting device, and, more particularly, a toy gun that emits light and includes the new and improved focusing.

### BACKGROUND

The prior art contains numerous examples of focusing methods and devices for light emitting devices, such as light emitting guns ranging from simple toys to more complicated markmanship training aids, as variously shown in, for example, U.S. Pat. No. 3,220,732 (Pincus); U.S. Pat. No. 3,271,032 (Rabinowitz et al.); U.S. Pat. No. 3,364,345 (Davis); U.S. Pat. No. 3,655,192 (Hall et al.); U.S. Pat. No. 3,891,216 (Ensmann et al.); U.S. Pat. No. 4,171,811 (Meyer et al.); U.S. Pat. No. 4,335,880 (Meyer, et al.);U.S. Pat. No. 4,397,468 (D'Andrade et al.); U.S. Pat. No. 4,830,617 (Hancox et al.);U.S. Pat. No. 5,375,847 (Fromm et al.); U.S. Pat. No. 5,437,463 (Fromm); U.S. Pat. No. 5,741,185 (Kwan et al.); and U.S. Pat. No. 6,328,651 (Lebensfeld et al.).

What is still desired, however, is a new and improved apparatus and method for collimating and focusing an emitted light from a device, such as a toy guy. Preferably, the new and improved apparatus and method will provide an inexpensive, robust, and effective means by which the emitted light may be adequately collimated and focused.

What is also desired is a new and improved toy target shooting set including a light emitting toy gun including a new and improved apparatus and method for collimating and focusing light emitted from the gun, a target stand including a light receiving module for causing the release of an extendable member, and a target for being placed over the member, so that a beam of light emitted from the toy gun and directed at the light receiving modules of the target stand will cause the release of the extendable member and the ejection of the target to simulate the target being hit by a bullet from the gun.

### SUMMARY

An exemplary embodiment of the present disclosure comprises a focusing system including an emitter configured to emit electromagnetic radiation of a predetermined spectrum, such as one of visible light and infrared light, and a plurality of focusing chambers. The emitter and the focusing chambers are arranged such that a beam of light from the emitter passes successively through the focusing chambers, and each chamber includes an aperture for focusing the light. In exemplary embodiments, the above-noted aspects of the disclosure are embodied in a toy pistol or the like, including but not limited to toy rifles, toy laser guns, or toy light wands.

Thus, among other benefits and features, the present disclosure provides a new and improved apparatus and method for collimating and focusing an emitted light from a device, such as a toy guy. The new and improved apparatus and method provides an inexpensive, robust, and effective means by which the emitted light may be adequately collimated and focused.

In one exemplary embodiment, a toy pistol is provided with an infrared (IR) emitter, which outputs light therefrom through a first focusing chamber and a first aperture and then through a second focusing chamber and second aperture before exiting the pistol. The focusing chambers and apertures collimate the light from the IR emitter. A stationary target stand bearing a photocell or receiving module may be advantageously arranged at a distance from the pistol and configured to register a “hit” when the light beam output from the gun passes over the target device photocell.

In one exemplary embodiment of a target device constructed in accordance with the present disclosure, the target stand includes spring-actuated members that impact against undersides of bottles, cans, or other target objects disposed thereover in response to the registering of a “hit” by the photocells of the target stand. The target objects are configured, in one aspect, to fracture or separate into at least two pieces to simulate a “hit” by a projectile, such as a bullet.

These aspects of the disclosure together with additional features and advantages thereof may best be understood by reference to the following detailed descriptions and examples taken in connection with the accompanying illustrated drawings.

### BRIEF DESCRIPTION OF THE DRAWINGS

FIG. 1 is a perspective view of an exemplary embodiment of a toy target shooting set constructed in accordance with the present disclosure and including a light emitting toy gun including a new and improved focusing apparatus, a target stand including a light receiving module for causing the release of an extendable member, and targets for being placed over the members of the target stand;

FIG. 2 is a perspective view of a portion of the target stand of FIG. 1, showing an extendable member of the target stand being manually reset prior to one of the targets being place over the reset member;

FIG. 3 is a perspective view of the target stand of FIG. 1, showing the targets being placed over the reset members of the target stand, and wherein two of the targets are provided separable pieces;

FIG. 4 is a side elevation view of the toy target shooting set of FIG. 1, with the toy gun shown in section, showing a beam of light emitted from a light emitter of the toy gun and directed at one of the light receiving modules of the target stand, which in turn is shown causing the release of one of the extendable members of the target stand and the ejection of one of the targets positioned over the member, and wherein the separable pieces of the target separate to simulate the target being hit by a bullet from the gun;

FIG. 5 is an enlarged side elevation view of the toy gun of FIG. 1, shown in section to reveal the light emitter of the gun, and first and second focusing chambers that are arranged such that a beam of light from the emitter passes successively through the focusing chambers, and wherein each chamber includes an aperture for focusing the light;

FIG. 6 is a further enlarged side elevation view, shown in section, of the first focusing chamber of the toy gun of FIG. 1; and

FIG. 7 is a sectional view of the target stand of FIG. 1, shown in section to reveal two of the four members of the target stand and a member release mechanism which is arranged and adapted to be triggered by the light receiving modules of the target stand.

Like reference characters designate identical or corresponding components and units throughout the several views.

### DETAILED DESCRIPTION OF EXEMPLARY EMBODIMENTS

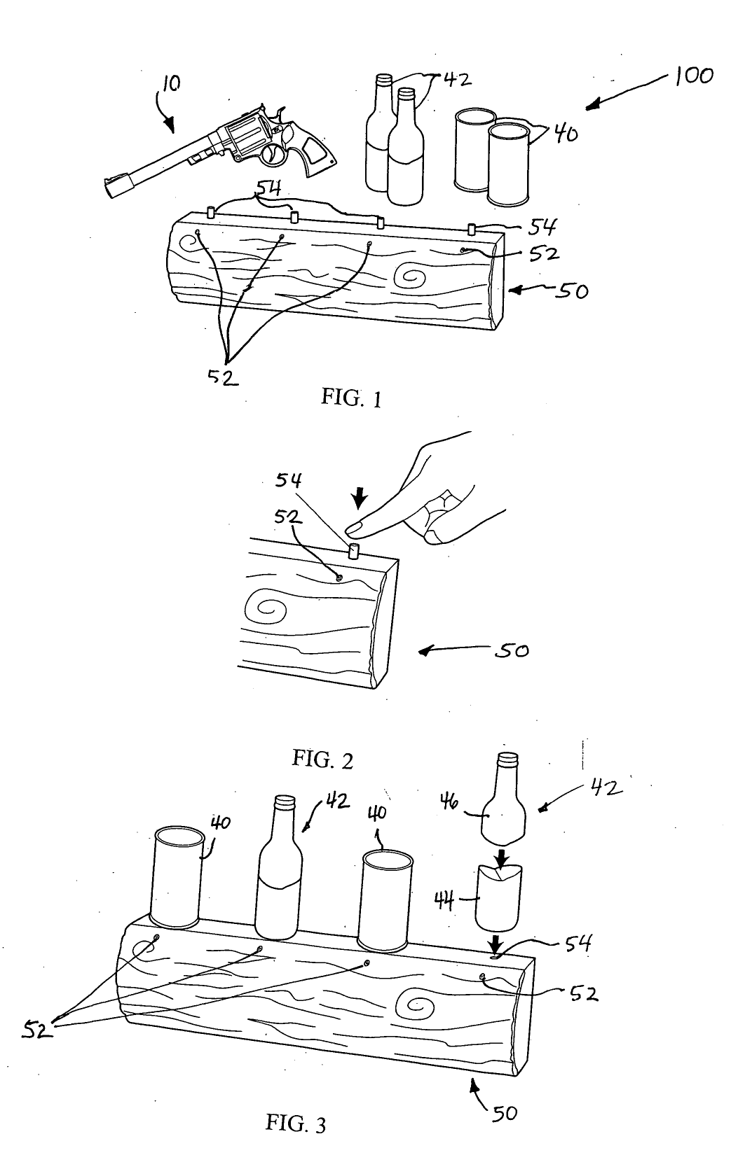

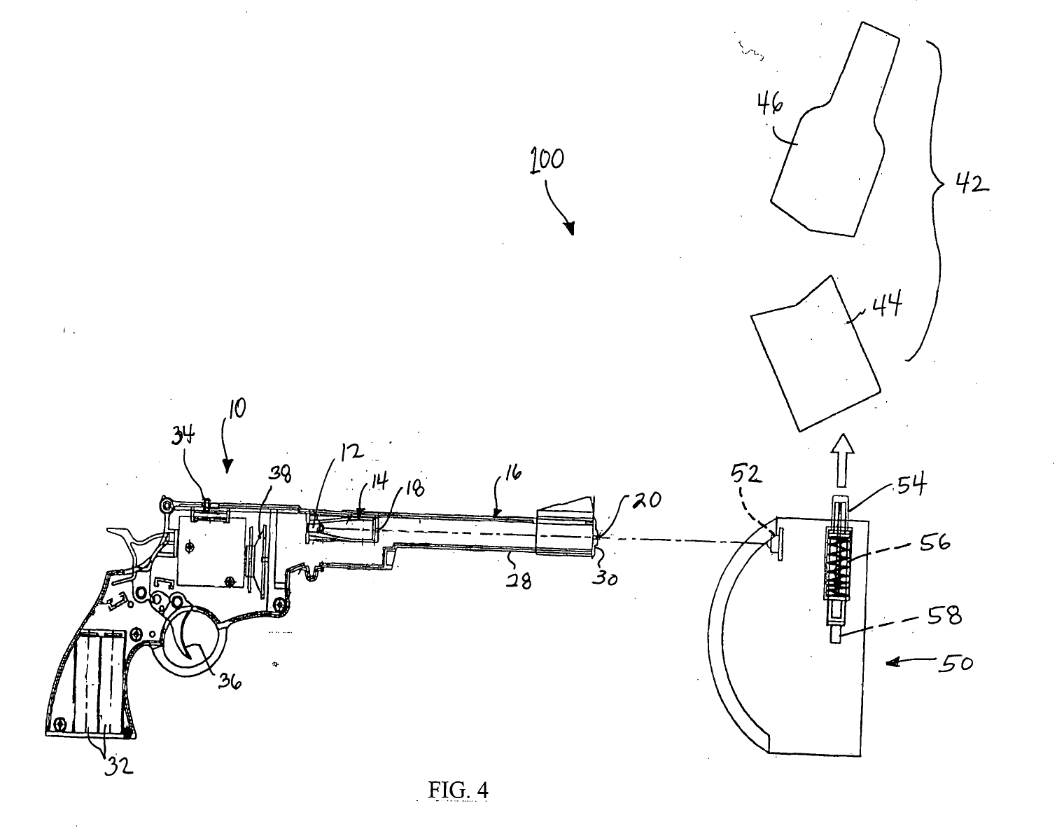

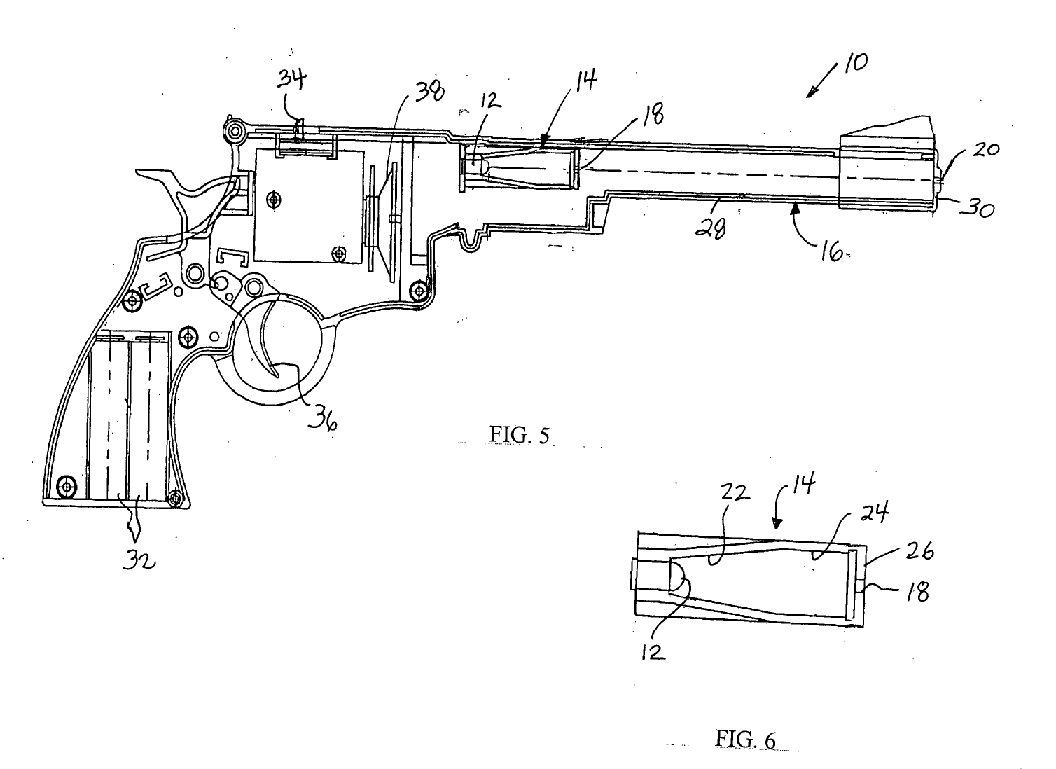

Referring to FIGS. 1, 4 and 5, an exemplary embodiment of a light emitting apparatus 10 constructed in accordance with the present disclosure is shown. As shown best in FIGS. 4 and 5, the apparatus 10 generally includes an emitter 12 configured to emit electromagnetic radiation of a predetermined spectrum including visible light and infrared light, and a plurality of focusing chambers 14, 16, with each focusing chamber having an aperture 18, 20. The emitter 12 and the focusing chambers 14, 16 are arranged so that light from the emitter 12 passes successively through a first of the chambers 14 and the aperture 18 of the first chamber, and through a second of the chambers 16 and the aperture 20 of the second chamber before exiting the apparatus 10.

The combination of the at least two focusing chambers 14, 16 and the apertures 18, 20 has been found to provide an inexpensive, robust, and effective means by which the emitted light is adequately collimated and focused. The chambers 14, 16 used in channeling the light beam appropriately narrows the light beam to a focus sufficient for accurate targeting, particularly at ranges typically involved in game play using toy guns or other toy-based light emitting devices. Multiple apertures can further refine the light emission to achieve a sharper light beam for targeting.

The light emitter can comprise an infrared (IR) light emitter 12. In the exemplary embodiment of FIGS. 1, 4 and 5, the light emitting apparatus comprises a toy pistol 10, the second focusing chamber comprises an elongated barrel 16 of the toy pistol 10 and the first focusing chamber 14 is positioned within an end of the elongated barrel 16. The disclosure contemplates disposition of the apertures 18, 20 at varying distances from one another and at varying distances from the emitter 12. In one aspect thereof, the distance from the emitter 12 to the first aperture 18 is advantageously selected based on a ratio of the length of the first focusing chamber 14 to the length of the second focusing chamber 16. For example, the ratio in length of the first focusing chamber 14 to the second focusing chamber 16 could be selected to be approximately 1:4. The apertures 18, 20 may be varied in diameter, depth, and shape (e.g., a non-circular aperture) to further define the output beam.

According to one exemplary embodiment, the first focusing chamber 14 is 44.5 mm long with a distance of 33.2 mm between the emitter 12 and the first aperture 18. The first focusing chamber 14, as also shown in FIG. 6, includes a first side wall 22, increasing in diameter with increasing distance from the emitter, extending to a second side wall 24, which has a constant diameter and extends to an end wall 26 defining the aperture 18. The first side wall 22 is made from or coated with light reflective material so that the first side wall 22 acts as a reflector and reflects light from the emitter 12 towards the end wall 26. In the exemplary embodiment shown, the aperture 18 of the first focusing chamber 14 has a diameter of about 2.4 mm and depth of about 1.9 mm, for example. The second focusing chamber 16 has a side wall 28 with a constant diameter of, for example, about 14.4 mm and extending to an end wall 30 disposed, for example, at a distance of about 174.1 mm from the emitter 12. The diameter of the second aperture 20 is, for example, about 2 mm.

In the configuration shown, wherein emitted light passes through the first focusing chamber 14 and the first aperture 18 and then through the second focusing chamber 16 and the second aperture 20, as configured, the output beam has a spot size or beam diameter of about 2 inches in diameter at a distance of 30 feet. At 50 feet, the beam diameter is about 8 inches with the illustrated configuration. At closer ranges, the multiple focusing chamber and aperture system of the disclosure can be utilized to produce a 1 inch beam at about 5 feet. Thus, the series of chambers 14, 16 used in channeling the beam appropriately narrows the beam to a focus sufficient for accurate targeting, particularly at ranges typically involved in game play using toy guns or other toy-based light emitting devices. Multiple apertures can further refine the light emission to achieve a sharper light beam for targeting.

The toy pistol 10 includes a suitable power source, such as replaceable batteries 32, an “on/off” switch 34 for connecting the power source to the IR light emitter 12, a trigger 36 connected to the IR light emitter 12 for activating the emitter, and a speaker 38 connected to the trigger 36 for simulating the report of gun-fire. The emitter 12 can be adapted, for example, to produce predetermined cycles of light when activated.

Referring to FIGS. 1 through 4, the present disclosure also provides an exemplary embodiment of a toy target shooting set 100 including the light emitting toy gun 10, a target stand 50 including light receiving modules 52 for causing the release of extendable members 54, and targets 40, 42 for being placed over the members 54 of the target stand 50. As shown in FIG. 2, the extendable members 54 of the target stand 50 can be manually reset prior to the targets 40, 42 being place over the reset members 54, as shown in FIG. 3, and a beam of light emitted from the light emitter 12 of the toy gun 10 can be aimed, or directed, at one of the light receiving modules 52 of the target stand 50, as shown best in FIG. 4, which in turn causes the release of one of the extendable members 54 of the target stand 50 and the ejection of one of the targets 40, 42 positioned over the member 54 to simulate the target 40, 42 being hit by a bullet from the gun 10.

As shown in FIGS. 1, 2 and 3, the targets can comprise replicas of bottles 42 and cans 40, and the targets can be provided in at least two separable pieces 44, 46. For example, the bottle replicas 42 are each provided in two separate pieces 44, 46 so that, when the bottles 42 are ejected off the target stand 50, the separable pieces 44, 46 of the target 43 separate to simulate the target 42 being hit and broken by a bullet from the gun 10. As shown best in FIGS. 1 through 3, the target stand 50 can be provided in the form of a replica of a cut log of wood, and can include four of the light receiving modules 52 and four of the extendable members 54 corresponding to each of the light receiving modules 52.

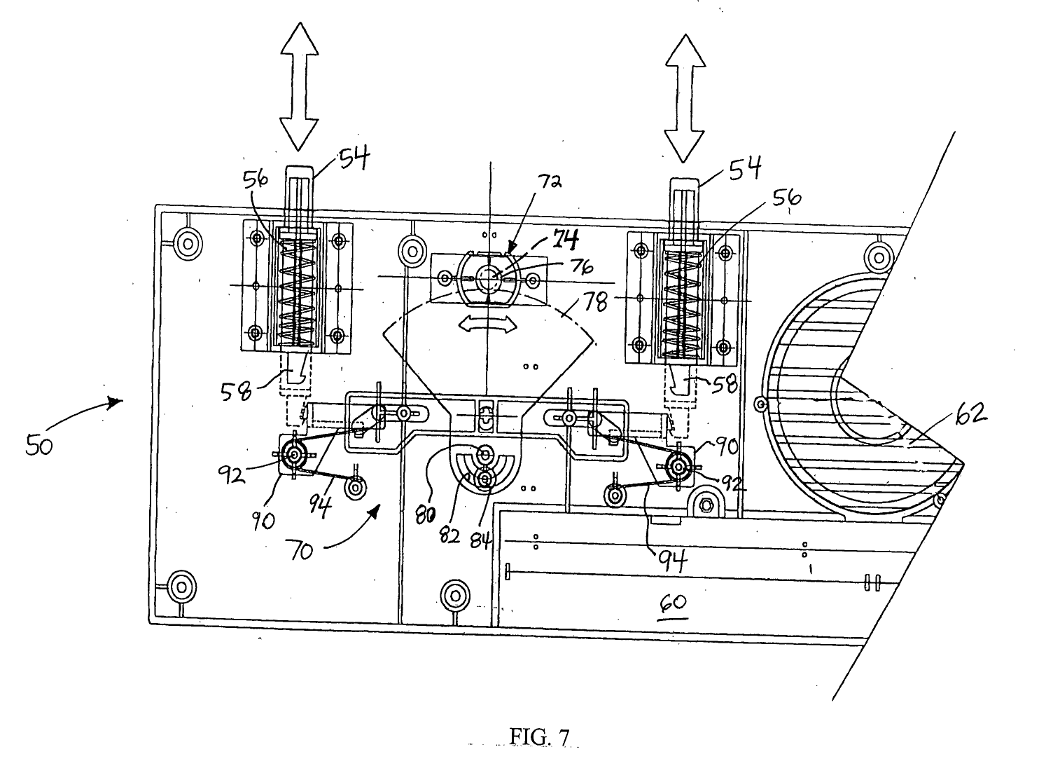

As shown best in FIG. 7, the target stand 50 includes a power source, such as replaceable batteries (in FIG. 7 only the battery compartment 60 is shown), connected to the light receiving modules 52, and at least one speaker 62 connected to the light receiving modules 52 to simulate the sound of a bullet ricocheting of the targets 40, 42 when the light receiving modules 52 receive a beam from the toy gun 10. Although not shown, the target stand 50 can also or alternatively include a light or lights connected to the light receiving modules 52 and adapted to turn on when the light receiving modules 52 receive a beam from the toy gun 10.

Still referring to FIG. 7, the target stand 50 further includes springs 56 normally biasing the extendable members 54 out of a top of the target stand 50 and latching mechanisms 70 for maintaining the extendable members 54 against the springs 56 and within the target stand 50. The latching mechanisms 70 are operatively connected to the light receiving modules 52 so that, upon a beam of light from the toy pistol 10 being received by one of the light receiving modules 52, the latching mechanisms 70 release the extendable members 54.

In the exemplary embodiment shown in FIG. 7, each of the latching mechanisms 70 includes a motor 72 having a rotatable shaft 74 and operatively connected to the light receiving modules 52 so that, upon a beam of light from the toy pistol 10 being received by the light receiving modules 52, the shaft 74 of the motor 72 is rotated. Latch members 90 normally engage hooks 58 of the extendable members 54 and maintain the extendable members 54 against the springs 56 and within the target stand 50. The latch members 90 are connected to the shaft 74 of the motor 72 so that, upon the shaft 74 being rotated, at least one of the latch members 90 release the hook 58 of the extendable member 54.

In the exemplary embodiment shown, the target stand 50 includes four of the extendable members 54, and one of the light receiving modules 52 is associated with each extendable member 54. The target stand 50 also includes two of the latching mechanisms 70, and each of the latching mechanisms 70 operatively connects two of the light receiving modules 52 to two of the extendable members 54. Thus, the latching mechanisms 70 are advantageously designed to share a single motor 72 between two of the of the extendable members 54.

Referring again to FIG. 7, the shaft 74 of the motor 72 is provided with a drive gear 76 which engages teeth of a driven gear 78. The shaft 74 of the motor 72 is adapted to rotate in opposite directions (i.e., reversible motor), depending upon which of two of the light receiving modules 52 is activated by the toy gun 10. The driven gear 78 is pivotally mounted at a fixed point 80 in the target stand 50, and includes a slot 82 slidable received on a fixed guide boss 84. Each latch member 90 is also pivotally mounted at fixed points 92, and includes a spring 94 biasing the latch members 90 into engagement with the hooks 58 of the extendable members 54. A connecting arm 86 connects two of the latch members 90 to the driven gear 78 so that pivotal movement of the driven gear 78 in a first of two directions (i.e., to the right in FIG. 7) causes one of the latch members 90 to release its corresponding extendable member 54, while pivotal movement of the driven gear 78 is a second of two directions (i.e., to the left in FIG. 7) causes the other of the latch members 90 to release its corresponding extendable member 54.

As an alternative to the stationary target stand, a movable target device or a wearable target device may be implemented in combination with the disclosure. Such target devices may register a “hit” by any physical manifestation or change of state resulting from a signal or carrier wave output from a target device photocell or other cell configured to detect a beam of electromagnetic radiation (e.g., light) output from the aforementioned emitter through the focusing or collimating chambers. The aforementioned signal or carrier wave would contain information representative of the “hit” and may be used to activate a light or speaker local to, or remote from, the target device.

Additional features of the present disclosure will become readily apparent to those skilled in the art from the following detailed description, wherein only aspects of the disclosure are shown and described, simply by way of illustration of the best mode presently known and contemplated for carrying out the disclosure. As will be realized, the disclosure is capable of other and different embodiments, and its several details are capable of modifications in various obvious respects, all without departing from the disclosure as defined in the appended claims. Accordingly, the drawings and description are to be regarded as illustrative in nature, and not as restrictive.

1-22. (canceled)

23. A light projecting component for a toy shooting device, comprising:
an emitter configured to emit electromagnetic radiation of a predetermined spectrum from the toy shooting device; and
a plurality of focusing chambers, each focusing chamber including an aperture, wherein light from the emitter passes successively through at least a first of the chambers and an aperture of the first chamber, and through a second of the chambers and an aperture of the second chamber before exiting the device.

24. The light emitting apparatus according to claim 23, wherein the emitter is disposed within the first chamber.

25. The light emitting apparatus according to claim 24, wherein the first chamber includes a first side wall increasing in diameter with increased distance from the emitter.

26. The light emitting apparatus according to claim 23, wherein the first chamber has a side wall including light-reflective material.

27. The light emitting apparatus according to claim 23, wherein the first chamber is disposed within the second chamber.

28. A light emitting apparatus according to claim 23, wherein the emitter is configured to emit infrared light.

29. A light emitting apparatus according to claim 23, wherein the apertures of the chambers are circular.

30. A light emitting apparatus according to claim 23, wherein the diameter of the aperture of the second chamber is less than an inner diameter of the second chamber.
